(19) United States
(12) Patent Application Publication
(10) Pub. No.: US 2022/0071217 A1
(43) Pub. Date: Mar. 10, 2022

(54) Microbial Hydrolysates for Agricultural Pest Control

(71) Applicant: Locus Agriculture IP Company, LLC, Solon, OH (US)

(72) Inventors: Sean FARMER, Ft. Lauderdale, FL (US); Ken ALIBEK, Solon, OH (US)

(21) Appl. No.: 17/418,823

(22) PCT Filed: Dec. 27, 2019
(86) PCT No.: PCT/US2019/068711

§ 371 Date: Jun. 27, 2021

Related U.S. Application Data
(60) Provisional application No. 62/788,222, filed on Jan. 4, 2019.

(51) Int. Cl. A01N 63/32; A01N 63/22; A01N 63/27; A01N 63/20; A01N 25/12; A01N 25/24; A01P 1/00

(52) U.S. Cl. CPC A01N 63/32; A01N 63/22; A01N 63/27; A01P 1/00; A01N 25/12; A01N 25/24; A01N 63/20

(57) ABSTRACT

The invention provides materials and method for controlling pests using a composition comprising microbial hydrolysates and microbial growth by-products. In preferred embodiments, the growthby-products are biosurfactants, such as glycolipids and/or lipopeptides. The composition can be used in combination with other pesticides or pest repellents, preferably which are naturally-derived.

### CROSS-REFERENCE TO RELATED APPLICATION

This application claims priority to U.S. Provisional Patent Application No. 62/788,222, filed Jan. 4, 2019, which is incorporated herein by reference in its entirety.

### BACKGROUND OF INVENTION

In the agriculture industry, certain common issues continue to hinder the ability of farmers to maximize production yields while keeping costs low. These include, but are not limited to, infections and infestations caused by bacteria, fungi, and other pests and pathogens. Environmental awareness and consumer demand has promoted the search for improved products for pest control and their use in the treatment of agricultural crops, particularly edible crops that are marketed from the field to the market.

Insects, in particular, significantly adversely affect agricultural production and human health. In addition to destroying agricultural products, insects transmit disease, some of which can cause epidemics. As one example, widespread infection of citrus plants by pathogens such as the pathogen that causes citrus greening disease has led to significant hardships for citrus growers. Entire crops have been lost to these bacterial infections, leading to a decline in the production, and increase in price, of citrus products worldwide.

Citrus greening disease, also known as Huanglongbing (HLB) or yellow dragon disease, is an incurable infection caused by the Gram-negative bacterium Candidatus Liberibacter asiaticus. This disease has caused devastation for millions of acres of citrus crops throughout the United States and other parts of the world. Infected trees produce fruits that are green, misshapen and bitter, which makes them unsuitable for sale as fresh fruit or for juice. Most infected trees die within a few years, as the disease is incurable. The disease is primarily spread by two species of psyllid insects. One species is the Asian citrus psyllid (ACP), Diaphorina citri, which has been present in the state of Florida (USA) since 1998.

Control of pests is usually attempted by the use of antibiotics, and/or by pesticides that function by poisoning via oral ingestion, by contact with the pest cuticle, or by fumigant action through the air. Unfortunately, the use of antibiotics and/or pesticides not only risks the contamination of the environment or agricultural products, but is also harmful to humans. In addition, the use of insecticides may unintentionally harm beneficial species, and the use of antibiotics can lead to the development of antibiotic-resistant bacterial strains.

Insect-proof barriers, such as meshes, are sometimes used to keep insects off crops, creating a barrier to help reduce the need for chemicals. Insect-proof barriers, however, are not always suitable to the physical situation in which protection from insects is required.

One alternative to the use of chemical insecticides or insect impermeable barriers is the use of insect repellents. Repellents cause insects to be driven away from, or to reject, a particular area or surface. Repellents have been used for the prevention of breeding, biting and stinging of various insect pests.

Various agents have been developed to be used as insect repellents for agricultural, gardening or other purposes. These agents range from naturally occurring extracts to commercially manufactured compounds. The degree of protection, duration of protection, and safety of these agents varies greatly. Examples of insect repellents include oils, such as mineral and vegetable oils, and synthetic chemicals such as N,N-Diethyl-meta-toluamide (DEET). DEET is the major chemical insect repellent in commercial use. In order for DEET to act as a repellent, it must be used at a concentration of about 5-20 volume percent (vol. %). DEET has been found to pose potential health risks, especially for children. Also, DEET has a limited spectrum of activity and a noticeably unpleasant odor.

As sources of air and water pollution, chemical pest control agents are increasingly scrutinized, making their responsible use an ecological and commercial imperative. Even when properly used, the over-dependence and long-term use of certain chemical pesticides and repellents alters soil ecosystems, reduces stress tolerance, increases pest resistance, and impedes plant and animal growth and vitality.

Thus, there is an urgent need for safe and sustainable methods and materials for controlling agricultural pests.

### BRIEF SUMMARY

The subject invention provides compositions and methods for controlling agricultural pests. In addition, the subject invention provides methods and compositions for preventing damage to crops from pests, thus resulting in yield increase. Advantageously, the pesticides according to the subject invention utilize non-toxic substances, such as microbes and by-products of microbial cultivation.

In certain embodiments, the subject invention provides a biopesticide composition for controlling agricultural pests, the composition comprising a hydrolysate of one or more biochemical-producing microorganisms. Preferably, the composition further comprises one or more biochemicals that were produced by the microorganisms during cultivation.

The biopesticide composition can be used to protect plants, humans, or animals by controlling and/or deterring plant pests.

In preferred embodiments, the microorganisms of the biopesticide composition are yeasts and/or bacteria. Yeasts can include, for example, Starmerella bombicola, Wickerhamomyces anomalus, Pseudozyma aphidis, Pichia guilliermondii and/or Saccharomyces cerevisiae. Bacteria can include, for example, Bacillus subtilis, Bacillus amyloliquefaciens, Bacillus licheniformis, Bacillus chitinosporous, Rhodococcus erythropolis and/or Pseudomonas chlororaphis.

In one embodiment, the one or more biochemicals are biosurfactants and/or enzymes. The biosurfactants can include, for example, low-molecular-weight glycolipids, cellobiose lipids, lipopeptides, flavolipids, phospholipids, and high-molecular-weight polymers such as lipoproteins, lipopolysaccharide-protein complexes, and/or polysaccharide-protein-fatty acid complexes.

In one embodiment, the biosurfactants comprise glycolipids such as, for example, rhamnolipids (RLP), sophorolipids (SLP), trehalose lipids or mannosylerythritol lipids (MEL). In one embodiment, the biosurfactants comprise lipopeptides, such as, e.g., surfactin, iturin, fengycin, viscosin and/or lichenysin. In one embodiment, the biosurfactants comprise polymeric biosurfactants, such as, for example, emulsan, lipomanan, alasan, and/or liposan.

Preferably, the total concentration of biosurfactants in the biopesticide composition is about 0.001 to 10.0%, preferably from about 0.01 to 5%, more preferably about 0.01 to 1%.

In one embodiment, the enzymes can include oxidoreductases, transferases, hydrolases, lyases, isomerases and ligases. In certain embodiments, the enzymes are chitinases, or killer yeast toxins, such as, e.g., exo-β-1,3-glucanase.

The biopesticide composition can further comprise natural pesticides and/or pest repellants. These can include, for example, diatomaceous earth, chitinase, lemon eucalyptus oil, citronella, peppermint oil, mineral oils, garlic extract, and/or chili extract.

The biopesticide composition can further comprise adherent substances, which are particularly useful for folial treatment. Adherent substances can include charged polymers or polysaccharides, such as, for example, xanthan gum, guar gum, levan, xylinan, welan gum, gellan gum, curdlan, and/or pullulan, which allow the composition to remain on the surfaces of plant vegetation for extended periods of time.

In certain embodiments, the biopesticide composition is produced by: a) producing a culture of a biochemical-producing microorganism in a nutrient medium using solid-state or submerged fermentation; b) allowing the culture to reach a desired cell density and/or a desired concentration of a biochemical; c) removing any remaining nutrient medium from the culture; d) inactivating the microorganism to produce a hydrolysate; e) drying the hydrolysate; and f) micronizing or blending the hydrolysate to remove any large clumps, thus producing a dry product in the form of granules or a powder.

The culture in a) can be obtained by cultivation processes ranging from small to large scales, including, but not limited to, submerged cultivation/fermentation, solid state fermentation (SSF), and hybrids, modifications and/or combinations thereof.

Preferably, the mode of inactivating the microorganism does not also inactivate or denature the biochemical(s) it produced during cultivation.

In some embodiments, a first and a second (and/or a third, a fourth, a fifth, etc.) hydrolysate can be mixed together to produce a blended hydrolysate product. Mixing can be performed after d), after e), and/or after f).

In one embodiment, the hydrolysates are autolysates, wherein a mode of inactivation in d) is chosen such that the mode of inactivation does not inactivate or denature the microorganism's endogenous digestive enzymes, and wherein the endogenous digestive enzymes activate autolysis of the microbial cells.

In preferred embodiments, the subject invention provides a method for controlling an agricultural pest, said method comprising applying an effective amount of the biopesticide composition to the pest, a plant and/or a plant's growing environment.

In certain embodiments, the biopesticide composition is mixed with water prior to application.

The microbe-based products of the subject invention may be applied, for example, through an irrigation system, as a spray, as a seed treatment, to soil, to plant surfaces, and/or to pest surfaces. Mechanical application through conventional handheld implements or robotic application through, e.g., aerial or ground-based drones is also facilitated.

The biopesticide composition can be used as a pest deterrent/repellent and/or as a pesticide. Thus, the subject invention can be used to prevent pest damage to a healthy plant or to prevent further pest damage to a plant already affected by a pest. Plant pests can include, for example, nematodes, arthropods, bacteria, viruses, fungi, protozoa, and parasites.

In certain embodiments, the methods and compositions according to the subject invention reduce damage to a plant caused by pests, compared to an untreated plant, by up to 1%, 5%, 10%, 20%, 30%, 40%, 50%, 60% 70%, 80%, or 90% or more.

In one embodiment, the methods and compositions according to the subject invention increase crop yield by at least 5%, 10%, 20%, 30%, 40%, 50%, 60% 70%, 80%, or 90% or more compared to an untreated crop.

In another embodiment, the methods and compositions according to the subject invention can increase plant biomass by at least 5%, 10%, 20%, 30%, 40%, 50%, 60% 70%, 80%, or 90% or more compared to an untreated plant.

Advantageously, the subject invention can be used without releasing large quantities of inorganic compounds into the environment. Additionally, the compositions and methods utilize components that are biodegradable and toxicologically safe. Thus, the present invention can be used as a “green” pesticide treatment.

### DETAILED DISCLOSURE

The subject invention provides compositions and methods for controlling agricultural pests. In addition, the subject invention provides methods and compositions for preventing damage to crops from pests, thus resulting in yield increase. Advantageously, the pesticides according to the subject invention utilize non-toxic substances, such as microbes and by-products of microbial cultivation.

In certain embodiments, the subject invention provides a biopesticide composition for controlling agricultural pests, the composition comprising a hydrolysate of one or more biochemical-producing microorganisms. Preferably, the composition further comprises one or more biochemicals that were produced by the microorganisms during cultivation.

In preferred embodiments, the subject invention provides a method for controlling an agricultural pest, said method comprising applying an effective amount of the biopesticide composition to the pest, a plant and/or a plant's growing environment.

The composition can be used as a pest deterrent/repellent and/or as a pesticide. Thus, the subject invention can be used to prevent pest damage to a healthy plant or to prevent further pest damage to a plant already affected by a pest. Plant pests can include, for example, nematodes, arthropods, bacteria, viruses, fungi, protozoa, and parasites.

### Selected Definitions

As used herein, reference to a “microbe-based composition” means a composition that comprises components that were produced as the result of the growth of microorganisms or other cell cultures. Thus, the microbe-based composition may comprise the microbes themselves and/or by-products of microbial growth. The microbes may be in a vegetative state, in spore or conidia form, in hyphae form, in any other form of propagule, or a mixture of these. The microbes may be planktonic or in a biofilm form, or a mixture of both. The by-products of growth may be, for example, metabolites, cell membrane components, proteins, and/or other cellular components. The microbes may be intact or lysed. The microbes may be present at, for example, a concentration of 1×10⁴, 1×10⁵, 1×10⁶, 1×10′ 1×10⁸, 1×10⁹, 1×10¹, 1×10¹¹, 1×10¹² or 1×10³ or more cells or propagules per gram or per ml of the composition.

The subject invention further provides “microbe-based products,” which are products that are to be applied in practice to achieve a desired result. The microbe-based product can be simply the microbe-based composition harvested from the microbe cultivation process. Alternatively, the microbe-based product may comprise further ingredients that have been added, or may have components removed therefrom. Additional ingredients can include, for example, stabilizers, buffers, appropriate carriers, such as water, salt solutions, or any other appropriate carriers, pesticides, adherents, agents that facilitate tracking of the microbes and/or the composition in the environment to which it is applied. The microbe-based product may also comprise mixtures of microbe-based compositions. The microbe-based product may also comprise one or more components of a microbe-based composition that have been processed in some way such as, but not limited to, filtering, centrifugation, lysing, drying, purification and the like.

The terms “natural” and “naturally-derived,” as used in the context of a compound or substance is a material that is found in nature, meaning that it is produced from earth processes or by a living organism. A natural product can be isolated or purified from its natural source of origin and utilized in, or incorporated into, a variety of applications, including foods, beverages, cosmetics, and supplements. A natural product can also be produced in a lab by chemical synthesis, provided no artificial components or ingredients (i.e., synthetic ingredients that cannot be found naturally as a product of the earth or a living organism) are added.

As used herein, an “isolated” or “purified” compound is substantially free of other compounds, such as cellular material, with which it is associated in nature. A purified or isolated polynucleotide (ribonucleic acid (RNA) or deoxyribonucleic acid (DNA)) is free of the genes or sequences that flank it in its naturally-occurring state. A purified or isolated polypeptide is free of the amino acids or sequences that flank it in its naturally-occurring state. “Isolated” in the context of a microbial strain means that the strain is removed from the environment in which it exists in nature. Thus, the isolated strain may exist as, for example, a biologically pure culture, or as spores (or other forms of the strain) in association with a carrier.

As used herein, a “biologically pure culture” is a culture that has been isolated from materials with which it is associated in nature. In a preferred embodiment, the culture has been isolated from all other living cells. In further preferred embodiments, the biologically pure culture has advantageous characteristics compared to a culture of the same microbe as it exists in nature. The advantageous characteristics can be, for example, enhanced production of one or more growth by-products.

In certain embodiments, purified compounds are at least 60% by weight the compound of interest. Preferably, the preparation is at least 75%, more preferably at least 90%, and most preferably at least 99%, by weight the compound of interest. For example, a purified compound is one that is at least 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

A “metabolite” refers to any substance produced by metabolism (e.g., a growth by-product) or a substance necessary for taking part in a particular metabolic process. A metabolite can be an organic compound that is a starting material, an intermediate in, or an end product of metabolism. Examples of metabolites include, but are not limited to, biosurfactants, biopolymers, enzymes, acids, solvents, alcohols, proteins, vitamins, minerals, microelements, and amino acids.

Ranges provided herein are understood to be shorthand for all of the values within the range. For example, a range of 1 to 20 is understood to include any number, combination of numbers, or sub-range from the group consisting of 1, 2, 3, 4, 5, 6, 7, 8, 9, 10, 11, 12, 13, 14, 15, 16, 17, 18, 19, 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein, “reduce” refers to a negative alteration, and the term “increase” refers to a positive alteration, each of at least: 1%, 5%, 10%, 25%, 50%, 75%, or 100%.

As used herein, “surfactant” refers to a compound that lowers the surface tension (or interfacial tension) between two liquids or between a liquid and a solid. Surfactants act as, e.g., detergents, wetting agents, emulsifiers, foaming agents, and dispersants. A “biosurfactant” is a surfactant produced by a living organism.

As used herein, “agriculture” means the cultivation and breeding of plants, algae and/or fungi for food, fiber, biofuel, medicines, cosmetics, supplements, ornamental purposes and other uses. According to the subject invention, agriculture can also include horticulture, landscaping, gardening, plant conservation, orcharding and arboriculture. Further included in agriculture is the care, monitoring and maintenance of soil.

As used herein, “prevention” means avoiding, delaying, forestalling, or minimizing the onset or progression of a particular situation or occurrence. Prevention can include, but does not require, absolute or complete prevention, meaning the situation or occurrence may still develop, but at a later time than it would without preventative measures. Prevention can include reducing the severity of the onset of a situation or occurrence, and/or inhibiting the progression of the situation or occurrence to a more severe situation or occurrence.

As used herein, the term “control” used in reference to a pest means killing, disabling, immobilizing, or reducing population numbers of a pest, or otherwise rendering the pest substantially incapable of causing harm.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates embodiments that “consist” or “consist essentially” of the recited elements.

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

All references cited herein are hereby incorporated by reference in their entirety.

### Biopesticide Compositions

In certain embodiments, the subject invention provides a biopesticide composition for controlling agricultural pests, the composition comprising a hydrolysate of one or more biochemical-producing microorganisms. Preferably, the composition further comprises one or more biochemicals that were produced by the microorganisms during cultivation.

The biopesticide composition can be used to protect plants, humans, or animals by controlling and/or deterring plant pests.

In preferred embodiments, the microorganisms of the biopesticide composition are yeasts and/or bacteria. Yeasts can include, for example, Starmerella bombicola, Wickerhamomyces anomalus, Pseudozyma aphidis, Pichia guilliermondii and/or Saccharomyces cerevisiae. Bacteria can include, for example, Bacillus subtilis, Bacillus amyloliquefaciens, Bacillus licheniformis, Bacillus chitinosporous, Rhodococcus erythropolis and/or Pseudomonas chlororaphis.

In one embodiment, the one or more biochemicals are biosurfactants and/or enzymes. Biosurfactants form an important class of secondary metabolites that occur in many microorganisms. Biosurfactants are biodegradable and can be produced using selected organisms on renewable substrates. Most biosurfactant-producing organisms produce biosurfactants in response to the presence of a hydrocarbon source (e.g., oils, sugar, glycerol, etc.) in the growing media.

Biosurfactants include glycolipids (GLs), lipopeptides (LPs), flavolipids (FLs), phospholipids, fatty acid esters, and high molecular weight polymers such as lipoproteins, lipopolysaccharide-protein complexes, and polysaccharide-protein-fatty acid complexes. The common lipophilic moiety of a biosurfactant molecule is the hydrocarbon chain of a fatty acid, whereas the hydrophilic part is formed by ester or alcohol groups of neutral lipids, by the carboxylate group of fatty acids or amino acids (or peptides), by an organic acid in the case of flavolipids, or, in the case of glycolipids, by a carbohydrate.

According to embodiments of this invention, the biosurfactant is able to penetrate through a pest's tissue sufficiently and is effective at low amounts without the use of adjuvants. It has been found that at concentrations above the critical micelle concentration (CMC), the biosurfactants are able to penetrate more effectively into treated objects than below the CMC.

In one embodiment, the biosurfactants comprise glycolipids such as, for example, rhamnolipids (RLP), sophorolipids (SLP), trehalose lipids, cellobiose lipids or mannosylerythritol lipids (MEL). In one embodiment, the biosurfactants comprise lipopeptides, such as, e.g., surfactin, iturin, fengycin, viscosin and/or lichenysin. In one embodiment, the biosurfactants comprise polymeric biosurfactants, such as, for example, emulsan, lipomanan, alasan, and/or liposan.

Preferably, the total concentration of biosurfactants in the biopesticide composition is about 0.001 to 10.0%, preferably from about 0.01 to 5%, more preferably about 0.01 to 1%.

In one embodiment, the enzymes can include oxidoreductases, transferases, hydrolases, lyases, isomerases and ligases. In certain embodiments, the enzymes are chitinases, or killer yeast toxins, such as, e.g., exo-β-1,3-glucanase.

In preferred embodiments, the microorganisms of the biopesticide composition have been deactivated after they are harvested from the fermentation vessel in which they were produced.

The biopesticide composition can further comprise natural pesticides and/or pest repellents. These can include, for example, diatomaceous earth, chitinase, lemon eucalyptus oil, citronella, peppermint oil, mineral oils, garlic extract, and/or chili extract.

The biopesticide composition can further comprise adherent substances, which are particularly useful for folial treatment. Adherent substances can include charged polymers or polysaccharide, such as, for example, xanthan gum, guar gum, levan, xylinan, welan gum, gellan gum, curdlan, or pullulan, which allow the composition to remain on the surfaces of plant vegetation for extended periods of time.

In some embodiments, the bio pesticide composition further serves as a pest deterrent or repellent. As used herein, the term “pest repellent” or “pest repellent composition” or “repellent composition” refers to a compound or composition that deters pests from a surface, e.g., plants. Typically, pest repellents are a compound or composition that can be either topically applied to a host, materials or surfaces; or, the compound or composition is incorporated into the host, materials or surface to produce a repellent article that deters pests from the nearby 2- or 3-dimensional space in which the host, materials or surface exists. The affect of the repellent is typically to drive the pests away from or to reject the host, materials or surface, e.g., plants, thereby minimizing the frequency of pest “bites” or settlement to the host, materials or surface, and protecting the, for example, plants from damage.

### Methods for Producing Microbial Culture

The subject invention provides methods for cultivation of microorganisms and production of microbial metabolites and/or other by-products of microbial growth. In one embodiment, the subject invention provides materials and methods for the production of biomass (e.g., viable cellular material), extracellular metabolites residual nutrients and/or intracellular components (e.g. enzymes and other proteins).

The growth vessel used for growing microorganisms can be any fermenter or cultivation reactor for industrial use. In one embodiment, the vessel may have functional controls/sensors or may be connected to functional controls/sensors to measure important factors in the cultivation process, such as pH, oxygen, pressure, temperature, agitator shaft power, humidity, viscosity and/or microbial density and/or metabolite concentration.

In a further embodiment, the vessel may also be able to monitor the growth of microorganisms inside the vessel (e.g., measurement of cell number and growth phases). Alternatively, a daily sample may be taken from the vessel and subjected to enumeration by techniques known in the art, such as dilution plating technique.

In one embodiment, the method includes supplementing the cultivation with a nitrogen source. The nitrogen source can be, for example, potassium nitrate, ammonium nitrate ammonium sulfate, ammonium phosphate, ammonia, urea, and/or ammonium chloride. These nitrogen sources may be used independently or in a combination of two or more.

The method can provide oxygenation to the growing culture. One embodiment utilizes slow motion of air to remove low-oxygen containing air and introduce oxygenated air. In the case of submerged fermentation, the oxygenated air may be ambient air supplemented daily through mechanisms including impellers for mechanical agitation of the liquid, and air spargers for supplying bubbles of gas to the liquid for dissolution of oxygen into the liquid.

The method can further comprise supplementing the cultivation with a carbon source. The carbon source is typically a carbohydrate, such as glucose, sucrose, lactose, fructose, trehalose, mannose, mannitol, and/or maltose; organic acids such as acetic acid, fumaric acid, citric acid, propionic acid, malic acid, malonic acid, and/or pyruvic acid; alcohols such as ethanol, isopropyl, propanol, butanol, pentanol, hexanol, isobutanol, and/or glycerol; fats and oils such as soybean oil, rice bran oil, canola oil, olive oil, corn oil, sesame oil, and/or linseed oil; etc. These carbon sources may be used independently or in a combination of two or more.

In one embodiment, the method comprises use of two carbon sources, one of which is a saturated oil selected from canola, vegetable, corn, coconut, olive, or any other oil suitable for use in, for example, cooking. In a specific embodiment, the saturated oil is 15% canola oil or discarded oil that has been used for cooking.

In one embodiment, the microorganisms can be grown on a solid or semi-solid substrate, such as, for example, corn, wheat, soybean, chickpeas, beans, oatmeal, pasta, rice, and/or flours or meals of any of these or other similar substances.

In one embodiment, growth factors and trace nutrients for microorganisms are included in the medium. This is particularly preferred when growing microbes that are incapable of producing all of the vitamins they require. Inorganic nutrients, including trace elements such as iron, zinc, copper, manganese, molybdenum and/or cobalt may also be included in the medium. Furthermore, sources of vitamins, essential amino acids, and microelements can be included, for example, in the form of flours or meals, such as corn flour, or in the form of extracts, such as yeast extract, potato extract, beef extract, soybean extract, banana peel extract, and the like, or in purified forms. Amino acids such as, for example, those useful for biosynthesis of proteins, can also be included.

In one embodiment, inorganic salts may also be included, e.g., potassium dihydrogen phosphate, dipotassium hydrogen phosphate, disodium hydrogen phosphate, magnesium sulfate, magnesium chloride, iron sulfate, iron chloride, manganese sulfate, manganese chloride, zinc sulfate, lead chloride, copper sulfate, calcium chloride, calcium carbonate, sodium chloride and/or sodium carbonate. These inorganic salts may be used independently or in a combination of two or more.

In some embodiments, the method for cultivation may further comprise adding additional acids and/or antimicrobials in the liquid medium before and/or during the cultivation process. Antimicrobial agents or antibiotics are used for protecting the culture against contamination. Additionally, antifoaming agents may also be added to prevent the formation and/or accumulation of foam when gas is produced during cultivation.

The pH of the mixture should be suitable for the microorganism of interest. Buffers, and pH regulators, such as carbonates and phosphates, may be used to stabilize pH near a preferred value. When metal ions are present in high concentrations, use of a chelating agent in the liquid medium may be necessary.

In one embodiment, the method for cultivation of microorganisms is carried out at about 5° to about 100° C., preferably, 15 to 60° C., more preferably, 25 to 50° C. In a further embodiment, the cultivation may be carried out continuously at a constant temperature. In another embodiment, the cultivation may be subject to changing temperatures.

In one embodiment, the equipment used in the method and cultivation process is sterile. The cultivation equipment such as the reactor/vessel may be separated from, but connected to, a sterilizing unit, e.g., an autoclave. The cultivation equipment may also have a sterilizing unit that sterilizes in situ before starting the inoculation. Air can be sterilized by methods know in the art. For example, the ambient air can pass through at least one filter before being introduced into the vessel. In other embodiments, the medium may be pasteurized or, optionally, no heat at all added, where the use of low water activity and low pH may be exploited to control undesirable bacterial growth.

In one embodiment, the subject invention provides methods of producing a microbial metabolite by cultivating a microbe strain of the subject invention under conditions appropriate for growth and production of the metabolite; and, optionally, purifying the metabolite. In a specific embodiment, the metabolite is a biosurfactant. The metabolite may also be, for example, ethanol, lactic acid, beta-glucan, proteins, amino acids, peptides, metabolic intermediates, polyunsaturated fatty acids, and lipids. The metabolite content produced by the method can be, for example, at least 20%, 30%, 40%, 50%, 60%, 70%, 80%, or 90%.

The biomass content of the fermentation medium may be, for example from 5 g/l to 180 g/l or more. In one embodiment, the solids content of the medium is from 10 g/l to 150 g/l.

The microbial growth by-product produced by microorganisms of interest may be retained in the microorganisms or secreted into the growth medium. In another embodiment, the method for producing microbial growth by-product may further comprise steps of concentrating and purifying the microbial growth by-product of interest. In a further embodiment, the medium may contain compounds that stabilize the activity of microbial growth by-product.

The method and equipment for cultivation of microorganisms and production of the microbial by-products can be performed in a batch, quasi-continuous, or continuous processes.

In one embodiment, all of the microbial culture is removed upon the completion of the cultivation (e.g., upon, for example, achieving a desired cell density, or density of a specified metabolite). In this batch procedure, an entirely new batch is initiated upon harvesting of the first batch.

In another embodiment, only a portion of the culture is removed at any one time. In this embodiment, biomass with viable cells remains in the vessel as an inoculant for a new cultivation batch. The composition that is removed can be a microbe-free medium or contain cells, spores, mycelia, conidia or other microbial propagules. In this manner, a quasi-continuous system is created.

Advantageously, the methods of cultivation do not require complicated equipment or high energy consumption. The microorganisms of interest can be cultivated at small or large scale on site and utilized, even being still-mixed with their media. Similarly, the microbial metabolites can also be produced at large quantities at the site of need. Thus, the microbe-based products can be produced in remote locations.

### Preparation of Microbe-Based Products

One microbe-based product of the subject invention is simply the fermentation medium containing the microorganism and/or the microbial metabolites (e.g., biosurfactants) produced by the microorganism and/or any residual nutrients. The product of fermentation may be used directly without extraction, isolation, or purification. If desired, extraction, isolation and/or purification can be easily achieved using standard methods or techniques described herein and/or in the literature.

The microbe-based products may be used without further stabilization, preservation, and storage. Advantageously, direct usage of these microbe-based products preserves a high viability of the microorganisms, reduces the possibility of contamination from foreign agents and undesirable microorganisms, and maintains the activity of the by-products of microbial growth.

The microbes and/or medium (including discrete layers or fractions) resulting from the microbial growth can be removed from the growth vessel and transferred via, for example, piping for immediate use.

In other embodiments, the composition (microbes, broth, or microbes and broth) can be placed in containers of appropriate size, taking into consideration, for example, the intended use, the contemplated method of application, the size of the fermentation tank, and any mode of transportation from microbe growth facility to the location of use. Thus, the containers into which the microbe-based composition is placed may be, for example, from 1 gallon to 1,000 gallons or more. In other embodiments the containers are 2 gallons, 5 gallons, 25 gallons, or larger.

As used herein “broth” includes the whole broth or fractions of the whole broth.

Upon harvesting the microbe-based composition from the growth vessels, further components can be added as the harvested product is placed into containers and/or piped (or otherwise transported for use). The additives can be, for example, buffers, carriers, other microbe-based compositions produced at the same or different facility, viscosity modifiers, preservatives, pH modifiers, nutrients for microbe growth, nutrients for plant growth, tracking agents, pesticides, herbicides, animal feed, food products and other ingredients specific for an intended use.

Advantageously, in accordance with the subject invention, the microbe-based product may comprise medium in which the microbes were grown. The product may be, for example, at least, by weight, 1%, 5%, 10%, 25%, 50%, 75%, or 100% broth. The amount of biomass in the product, by weight, may be, for example, anywhere from 0% to 100% inclusive of all percentages therebetween.

Optionally, the product can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 20° C., 15° C., 10° C., or 5° C. On the other hand, a biosurfactant composition can typically be stored for longer periods of time and at ambient temperatures.

In certain embodiments, the microbe-based product is a biopesticide composition of the subject invention. The biopesticide can be produced by: a) producing a culture of a biochemical-producing microorganism in a nutrient medium using solid-state or submerged fermentation; b) allowing the culture to reach a desired cell density and/or a desired concentration of a biochemical; c) removing any remaining nutrient medium from the culture; d) inactivating the microorganism to produce a hydrolysate; e) drying the hydrolysate; and f) micronizing or blending the hydrolysate to remove any large clumps, thus producing a dry product in the form of granules or a powder.

The culture in a) can be obtained by cultivation processes ranging from small to large scales, including, for example, as described in previous sections.

Preferably, the mode of inactivating the microorganism does not also inactivate or denature the biochemical(s) it produced during cultivation. Inactivation can be achieved using, for example, boiling, dry-heat oven, autoclaving, pasteurization, refrigeration, freezing, high-pressure processing, hyperbaric oxygen therapy, desiccation, lyophilization, radiation, sonication, HEPA (high-efficiency particulate air) filtration, or membrane filtration.

In preferred embodiments, when the biochemical is an enzyme, the mode of inactivation does not utilize high-heat methods that would denature the enzyme. However, biosurfactants can withstand high temperatures more easily.

According to the subject invention, a “hydrolysate” of a microorganism comprises disrupted cell walls/membranes of a deactivated microorganism, along with the cell contents released therefrom. The process of deactivating, or hydrolysis, often causes the release of compounds from the cells and cell walls/membranes, such as metabolites, enzymes, proteins, peptides, free amino acids, vitamins, minerals and trace elements.

In some embodiments, a first and a second (and/or a third, a fourth, a fifth, etc.) hydrolysate can be mixed together to produce a blended hydrolysate product. Mixing can be performed after d), after e), and/or after f).

In one embodiment, the hydrolysates are autolysates, wherein a mode of inactivation in d) is chosen such that the mode of inactivation does not inactivate or denature the microorganism's endogenous digestive enzymes, and wherein the endogenous digestive enzymes activate autolysis of the microbial cells.

In one embodiment, the cultivation products may be prepared as a spray-dried biomass product. The biomass may be separated by known methods, such as centrifugation, filtration, separation, decanting, a combination of separation and decanting, ultrafiltration or microfiltration. The biomass product may be separated from the cultivation medium, and spray-dried.

The microbe-based products may be formulated in a variety of ways, including liquid, solids, granular, dust, or slow release products by means that will be understood by those of skill in the art having the benefit of the instant disclosure.

Solid formulations of the invention may have different forms and shapes such as cylinders, rods, blocks, capsules, tablets, pills, pellets, strips, spikes, etc. Solid formulations may also be milled, granulated or powdered. The granulated or powdered material may be pressed into tablets or used to fill pre-manufactured gelatin capsules or shells. Semi solid formulations can be prepared in paste, wax, gel, or cream preparations.

The solid or semi-solid compositions of the invention can be coated using film-coating compounds such as polyethylene glycol, gelatin, sorbitol, gum, sugar or polyvinyl alcohol. This is particularly essential for tablets or capsules used in pesticide formulations. Film coating can protect the handler from coming in direct contact with the active ingredient in the formulations. In addition, a bittering agent such as denatonium benzoate or quassin may also be incorporated in the pesticidal formulations, the coating or both.

The compositions of the invention can also be prepared in powder formulations and used as-is, or, optionally, filled into pre-manufactured gelatin capsules.

The concentrations of the ingredients in the formulations and application rate of the compositions may be varied widely depending on the pest, plant or area treated, or method of application.

The composition may be used either alone or combined with other acceptable active or inactive components. These components can be, for example, natural pesticides and/or pest repellents, as well as adherent substances, which are particularly useful for folial treatment.

Adherent substances can include charged polymers or polysaccharides, such as, for example, xanthan gum, guar gum, levan, xylinan, welan gum, gellan gum, curdlan, or pullulan, which allow the composition to remain on the surfaces of plant vegetation for extended periods of time.

The composition can comprise and/or be used alongside an oil component such as cinnamon oil, clove oil, cottonseed oil, garlic oil, or rosemary oil; another natural surfactant such as Yucca or Quillaja saponins; or the component may be an aldehyde such as cinnamic aldehyde. Other oils that may be used as a pesticidal component or adjuvants include: almond oil, camphor oil, castor oil, cedar oil, citronella oil, citrus oil, coconut oil, corn oil, eucalyptus oil, fish oil, geranium oil, lecithin, lemon eucalyptus oil, lemon grass oil, linseed oil, mineral oil, mint or peppermint oil, olive oil, pine oil, rapeseed oil, safflower oil, sage oils, sesame seed oil, sweet orange oil, thyme oil, vegetable oil, and wintergreen oil.

Additional naturally-derived pesticides can include, for example, diatomaceous earth, chitinase, citronella, garlic extract, and/or chili extract.

Other suitable additives, which may be contained in the formulations according to the invention, include substances that are customarily used for such preparations. Example of such additives include adjuvants, surfactants, emulsifying agents, plant nutrients, fillers, plasticizers, lubricants, glidants, colorants, pigments, bittering agents, buffering agents, solubility controlling agents, pH adjusting agents, preservatives, stabilizers and ultra-violet light resistant agents. Stiffening or hardening agents may also be incorporated to strengthen the formulations and make them strong enough to resist pressure or force in certain applications such as soil, root flare or tree injection tablets.

In one embodiment, the composition may further comprise buffering agents including organic and amino acids or their salts. Suitable buffers include citrate, gluconate, tartarate, malate, acetate, lactate, oxalate, aspartate, malonate, glucoheptonate, pyruvate, galactarate, glucarate, tartronate, glutamate, glycine, lysine, glutamine, methionine, cysteine, arginine and a mixture thereof. Phosphoric and phosphorous acids or their salts may also be used. Synthetic buffers are suitable to be used but it is preferable to use natural buffers such as organic and amino acids or their salts listed above.

In a further embodiment, pH adjusting agents include potassium hydroxide, ammonium hydroxide, potassium carbonate or bicarbonate, hydrochloric acid, nitric acid, sulfuric acid or a mixture.

In one embodiment, additional components such as sodium bicarbonate or carbonate, sodium sulfate, sodium phosphate, sodium biphosphate, can be included in the formulation.

### Local Production of Microbe-Based Products

In certain embodiments of the subject invention, a microbe growth facility produces fresh, high-density microorganisms and/or microbial growth by-products of interest on a desired scale. The microbe growth facility may be located at or near the site of application. The facility produces high-density microbe-based compositions in batch, quasi-continuous, or continuous cultivation.

The microbe growth facilities of the subject invention can be located at the location where the microbe-based product will be used (e.g., a citrus grove). For example, the microbe growth facility may be less than 300, 250, 200, 150, 100, 75, 50, 25, 15, 10, 5, 3, or 1 mile from the location of use.

Because the microbe-based product can be generated locally, without resort to the microorganism stabilization, preservation, storage and transportation processes of conventional microbial production, a much higher density of microorganisms can be generated, thereby requiring a smaller volume of the microbe-based product for use in the on-site application or which allows much higher density microbial applications where necessary to achieve the desired efficacy. This allows for a scaled-down bioreactor (e.g., smaller fermentation vessel, smaller supplies of starter material, nutrients and pH control agents), which makes the system efficient and can eliminate the need to stabilize cells or separate them from their culture medium. Local generation of the microbe-based product also facilitates the inclusion of the growth medium in the product, when desired. The medium can contain agents produced during the fermentation that are particularly well-suited for local use.

Locally-produced high density, robust cultures of microbes are more effective in the field than those that have remained in the supply chain for some time. The microbe-based products of the subject invention are particularly advantageous compared to traditional products wherein cells have been separated from metabolites present in the fermentation growth media. Reduced transportation times allow for the production and delivery of fresh batches of microbes and/or their metabolites at the time and volume as required by local demand.

The microbe growth facilities of the subject invention produce fresh, microbe-based compositions, comprising the microbes themselves, microbial metabolites, and/or other components of the medium in which the microbes are grown. If desired, the compositions can have a high density of vegetative cells or propagules, or a mixture of vegetative cells and propagules.

In one embodiment, the microbe growth facility is located on, or near, a site where the microbe-based products will be used (e.g., a citrus grove), for example, within 300 miles, 200 miles, or even within 100 miles. Advantageously, this allows for the compositions to be tailored for use at a specified location. The formula and potency of microbe-based compositions can be customized for specific local conditions at the time of application, such as, for example, which soil type, plant and/or crop is being treated; what season, climate and/or time of year it is when a composition is being applied; and what mode and/or rate of application is being utilized.

Advantageously, distributed microbe growth facilities provide a solution to the current problem of relying on far-flung industrial-sized producers whose product quality suffers due to upstream processing delays, supply chain bottlenecks, improper storage, and other contingencies that inhibit the timely delivery and application of, for example, a viable, high cell-count product and the associated medium and metabolites in which the cells are originally grown.

Furthermore, by producing a composition locally, the formulation and potency can be adjusted in real time to a specific location and the conditions present at the time of application. This provides advantages over compositions that are pre-made in a central location and have, for example, set ratios and formulations that may not be optimal for a given location.

The microbe growth facilities provide manufacturing versatility by their ability to tailor the microbe-based products to improve synergies with destination geographies. Advantageously, in preferred embodiments, the systems of the subject invention harness the power of naturally-occurring local microorganisms and their metabolic by-products to improve plant health, root growth and productivity.

The cultivation time for the individual vessels may be, for example, from 1 to 7 days or longer. The cultivation product can be harvested in any of a number of different ways.

Local production and delivery within, for example, 24 hours of fermentation results in pure, high cell density compositions and substantially lower shipping costs. Given the prospects for rapid advancement in the development of more effective and powerful microbial inoculants, consumers will benefit greatly from this ability to rapidly deliver microbe-based products.

### Microorganisms

The microorganisms that can be grown according to the subject methods can be, for example, bacteria, yeast and/or fungi. These microorganisms may be natural, or genetically modified microorganisms. For example, the microorganisms may be transformed with specific genes to exhibit specific characteristics. The microorganisms may also be mutants of a desired strain. As used herein, “mutant” means a strain, genetic variant or subtype of a reference microorganism, wherein the mutant has one or more genetic variations (e.g., a point mutation, missense mutation, nonsense mutation, deletion, duplication, frameshift mutation or repeat expansion) as compared to the reference microorganism. Procedures for making mutants are well known in the microbiological art. For example, UV mutagenesis and nitrosoguanidine are used extensively toward this end.

In preferred embodiments, the microorganism is any yeast or fungus. Examples of yeast and fungus species suitable for use according to the current invention, include, but are not limited to, Acaulospora, Aspergillus, Aureobasidium (e.g., A. pullulans), Blakeslea, Candida (e.g., C. albicans, C. apicola), Debaryomyces (e.g., D. hansenii), Entomophthora, Fusarium, Hanseniaspora (e.g., H. uvarum), Hansenula, Issatchenkia, Kluyveromyces, Mortierella, Mucor (e.g., M. piriformis), Penicillium, Phythium, Phycomyces, Pichia (e.g., P. anomala, P. guielliermondii, P. occidentalis, P. kudriavzevii), Pseudozyma (e.g., P. aphidis), Rhizopus, Saccharomyces (S. cerevisiae, S. boulardii sequela, S. torula), Starmerella (e.g., S. bombicola), Torulopsis, Thraustochytrium, Trichoderma (e.g., T. reesei, T. harzianum, T. virens), Ustilago (e.g., U. maydis), Wickerhamomyces (e.g., W. anomalus), Williopsis, Zygosaccharomyces (e.g., Z. bailii).

In one embodiment, the microorganism is any yeast known as a “killer yeast.” As used herein, “killer yeast” means a strain of yeast characterized by its secretion of toxic proteins or glycoproteins, to which the strain itself is immune. The exotoxins secreted by killer yeasts are capable of killing other strains of yeast, fungi, or bacteria. Killer yeasts can include, but are not limited to, Wickerhamomyces, Pichia, Hansenula, Saccharomyces, Hanseniaspora, Ustilago Debaryomyces, Candida, Cryptococcus, Kluyveromyces, Torulopsis, Williopsis, Zygosaccharomyces and others.

In one embodiment, the microorganism is Starmerella bombicola, Wickerhamomyces anomalus, Pseudozyma aphidis, Pichia guilliermondii or Saccharomyces cerevisiae. These yeasts are effective producers of, for example, glycolipid biosurfactants.

In one embodiment, the microorganism strain is a Pichia yeast selected from Pichia anomala (Wickerhamomyces anomalus), Pichia guilliermondii, and Pichia kudriavzevii. Pichia anomala, in particular, is an effective producer of exo-β-1,3-glucanase, glycolipid biosurfactants that are capable of reducing surface/interfacial tension of water, as well as various other useful solvents, enzymes and metabolites, such as phytase, glycosidases, ethyl acetate, acetic acid, lactic acid, isopropyl alcohol and ethanol.

In some embodiments, the microorganisms are bacteria, including Gram-positive and Gram-negative bacteria. Bacteria suitable for use according to the present invention include, for example, Acinetobacter (e.g., A. calcoaceticus, A. venetianus); Agrobacterium (e.g., A. radiobacter), Azotobacter (A. vinelandii, A. chroococcum), Azospirillum (e.g., A. brasiliensis), Bacillus (e.g., B. amyloliquefaciens, B. firmus, B. laterosporus, B. licheniformis, B. megaterium, B. mucilaginosus, B. subtilis, B. coagulan), Chlorobiaceae spp., Dyadobacter fermenters, Frankia spp., Frateuria (e.g., F. aurantia), Klebsiella spp., Microbacterium (e.g., M. laevaniformans), Pantoea (e.g., P. agglomerans), Pseudomonas (e.g., P. aeruginosa, P. chlororaphis, P. chlororaphis subsp. aureofaciens (Kluyver), P. putida), Rhizobium spp., Rhodospirillum (e.g., R. rubrum), Sphingomonas (e.g., S. paucimobilis), and/or Xanthomonas spp.

In one embodiment, the bacteria are Bacillus subtilis, Bacillus amyloliquefaciens, Bacillus licheniformis, Bacillus chitinosporous, Rhodococcus erythropolis or Pseudomonas chlororaphis.

In one embodiment, the microorganism is a Bacillus sp., such as, B. subtilis, B. amyloliquefaciens, or B. licheniformis, which are effective producers of, for example, lipopeptide biosurfactants.

In one embodiment, the microbe is a non-pathogenic strain of Pseudomonas (e.g., P. chlororaphis). Preferably, the strain is a producer of glycolipid biosurfactants, including, for example, rhamnolipid biosurfactants.

In one embodiment, the microbe is a Rhodococcus spp. (e.g., R. erythopolis) capable of producing glycolipids, e.g., trehalose lipids.

Other microbial strains can be used in accordance with the subject invention, including, for example, any other strains having high concentrations of mannoprotein and/or beta-glucan in their cell walls and/or that are capable of producing biosurfactants, enzymes and other metabolites useful for controlling pests.

### Application of the Microbe-Based Products

In preferred embodiments, the subject invention provides a method for controlling an agricultural pest, said method comprising applying an effective amount of the biopesticide composition of the subject invention to the pest, a plant and/or a plant's growing environment.

As used herein, “applying” a composition or product to an environment refers to contacting a composition or product with a target or site such that the composition or product can have an effect on that target or site. The effect can be due to, for example, the action of a metabolite, enzyme, or biosurfactant.

Application can further include contacting the microbe-based product directly with a plant, plant part, and/or on or near the plant's surrounding environment (e.g., the soil and/or the rhizosphere). The microbe-product can be applied as a seed treatment or to the soil surface, or to the surface of a plant or plant part (e.g., to the surface of the roots, tubers, stems, flowers, leaves, fruit, or flowers). It can be sprayed, poured, sprinkled, injected or spread as liquid, dry powder, dust, granules, microgranules, pellets, wettable powder, flowable powder, emulsions, microcapsules, oils, gels, pastes or aerosols.

In certain embodiments, the biopesticide composition is applied after the composition has been prepared, for example, by dissolving dried powder or granules in water.

In a specific embodiment, the composition is contacted with one or more roots of the plant. The composition can be applied directly to the roots, e.g., by spraying or dunking the roots, and/or indirectly, e.g., by administering the composition to the soil in which the plant grows (or the rhizosphere). The composition can be applied to the seeds of the plant prior to or at the time of planting, or to any other part of the plant and/or its surrounding environment.

In one embodiment, wherein the method is used in a large scale setting, such as in a citrus grove or an agricultural crop, the method can comprise administering the biopesticide composition into a tank connected to an irrigation system used for supplying water, fertilizers, pesticides or other liquid compositions to a crop, orchard or field. Thus, the plant and/or soil surrounding the plant can be treated with the composition via, for example, soil injection, soil drenching, using a center pivot irrigation system, with a spray over the seed furrow, with micro-jets, with drench sprayers, with boom sprayers, with sprinklers and/or with drip irrigators. Advantageously, the method is suitable for treating hundreds of acres of crops, orchards or fields at one time.

In one embodiment, wherein the method is used in a smaller scale setting, such as in a home garden or greenhouse, the method can comprise spraying a plant and/or its surrounding environment with the composition using a handheld lawn and garden sprayer. The composition can also be applied using a standard handheld watering can.

Plants and/or their environments can be treated at any point during the process of cultivating the plant. For example, the composition can be applied to the soil prior to, concurrently with, or after the time when seeds are planted therein. It can also be applied at any point thereafter during the development and growth of the plant, including when the plant is flowering, fruiting, and during and/or after abscission of leaves.

In certain embodiments, the plant receiving treatment is healthy, meaning it is free from injury or illness. Advantageously, the subject invention can be useful for enhancing the immune response of a plant having a compromised immune system, for example, because the plant is affected by disease and/or disease symptoms.

The biopesticide composition can be used as a pest deterrent/repellent and/or as a pesticide. Thus, the subject invention can be used to prevent pest damage to a healthy plant or to prevent further pest damage to a plant already affected by a pest. Plant pests can include, for example, nematodes, arthropods, bacteria, viruses, fungi, protozoa, and parasites.

In certain embodiments, the methods and compositions according to the subject invention reduce damage to a plant caused by pests, compared to an untreated plant, by up to 1%, 5%, 10%, 20%, 30%, 40%, 50%, 60% 70%, 80%, or 90% or more.

In one embodiment, the subject invention provides a method of increasing crop or plant yield. In certain embodiments, the methods and compositions according to the subject invention increase crop yield by at least 5%, 10%, 20%, 30%, 40%, 50%, 60% 70%, 80%, or 90% or more compared to an untreated crop.

In another embodiment, the subject invention provides a method of increasing above-and/or below-ground plant biomass relative to an untreated plant. Plant biomass can be increased by at least 5%, 10%, 20%, 30%, 40%, 50%, 60% 70%, 80%, or 90% or more compared to an untreated plant.

In one embodiment, the composition according to the subject invention maybe applied at about 0.0001 pounds/acre to about 10 pounds/acre, about 0.001 pounds/acre to about 5 pounds/acre, about 0.01 pounds/acre to about 1 pounds/acre, about 0.01 pounds/acre to about 0.1 pounds/acre, or about 0.01 pounds/acre to about 0.05 pounds/acre.

In one embodiment, the composition according to the subject invention is reapplied to the plant or crop from about 1 to about 100 days, about 2 to about 50 days, about 10 to about 40 days, about 20 to about 30 days after an initial application to, e.g., the soil or seed.

In certain embodiments, the compositions provided herein are applied to the soil surface without mechanical incorporation. The beneficial effect of the soil application can be activated by rainfall, sprinkler, flood, or drip irrigation, and subsequently delivered to, for example, targeted pests in order to drive their population levels down to acceptable thresholds or to the roots of plants to influence the root microbiome or facilitate uptake of the microbial product into the vascular system of the crop or plant to which the microbial product is applied. In an exemplary embodiment, the compositions provided herein can be efficiently applied via a center pivot irrigation system or with a spray over the seed furrow.

The microbe-based products can be used either alone or in combination with other compounds for efficient enhancement of plant immunity, health, growth and/or yields, as well as other compounds for efficient treatment and prevention of plant pathogenic pests. For example, commercial and/or natural fertilizers, antibiotics, pesticides, herbicides and/or soil amendments can be applied alongside the biopesticide composition.

In certain embodiments, the microbe-based products can be used to enhance the effectiveness of the other compounds, for example, by enhancing the penetration of a drug compound into a plant or pest.

### Target Pests

As used herein, a “pest” is any organism, other than a human, that is destructive, deleterious and/or detrimental to humans or human concerns (e.g., agriculture). Pests may cause and/or carry agents that cause infections, infestations and/or disease. Pests may cause direct harm, for example, by eating parts of a plant. Pests may be single- or multi-cellular organisms, including but not limited to, bacteria, viruses, fungi, parasites, protozoa, arthropods and/or nematodes.

In one embodiment, the pest is a pathogenic bacteria. For example, the plant may be affected by a pathogenic strain of Pseudomonas (e.g., P. savastanoi, P. syringae pathovars); Ralstonia solanacearum; Agrobacterium (e.g., A. tumefaciens); Xanthomonas (e.g., X. oryzae pv. Oryzae, X. campestris pathovars, X. axonopodis pathovars); Erwinia (e.g., E. amylovora); Xylella (e.g., X fastidiosa); Dickeya (e.g., D. dadantii and D. solani); Pectobacterium (e.g., P. carotovorum and P. atrosepticum); Clavibacter (e.g., C. michiganensis and C. sepedonicus); Candidatus Liberibacter asiaticus; Pantoea; Burkholderia; Acidovorax; Streptomyces; Spiroplasma; and/or Phytoplasma; as well as huanglongbing (HLB, citrus greening disease), citrus canker disease, citrus bacterial spot disease, citrus variegated chlorosis, brown rot, citrus root rot, citrus and black spot disease.

In some embodiments, the pest is a disease vector, i.e., a carrier for a pathogenic agent such as a bacteria, fungus, parasite or virus. In some plant diseases caused by plant pathogenic bacteria (especially in those that cause spots, cankers, blights, galls, or soft rots), the bacteria can escape to the surface of their host plants as droplets or masses of sticky exudates. The bacterial exudates are released through cracks or wounds in the infected area, or through natural openings in the infected area of the plant. Such bacteria are then likely to stick on the legs and bodies of insects, such as flies, aphids, ants, beetles, whiteflies, etc., that land on the plant and come in contact with the substance.

When the insects move to other parts of the plant or to other susceptible host plants, they carry numerous bacteria on their body. If the insects happen to land on a fresh wound or on a natural opening in a plant, and there is enough moisture on the plant surface, the bacteria may multiply, move into the plant, and begin a new infection. Thus, the subject methods can prevent the spread of plant pathogens by controlling, i.e., killing, these carrier pests.

In some embodiments, the pest is an arthropod, which includes insects. As used herein, the term “insect” refers to any member of a large group of invertebrate animals characterized in the adult state by division of the body into head, thorax, and abdomen, three pairs of legs, and, often (but not always) two pairs of membranous wings. This definition therefore includes, but not limited to a variety of biting insects (e.g., ants, bees, black flies, chiggers, fleas, green head flies, mosquitoes, stable flies, ticks, and wasps), Wood-boring insects (e.g., termites), noxious insects (e.g., house flies, cockroaches, lice, roaches, and wood lice), and household pests (e.g., flour and bean beetles, dust mites, moths, silverfish, bed bugs, carpet beetles, furniture beetles, book lice, clothes moths, spiders and weevils). Other examples include locusts, caterpillars, bugs, hoppers, and aphids. This definition also includes non-adult insect states include larva and pupa.

Examples of arthropods include, but are not limited to, grasshoppers, mites, thrips, aphids, mealybugs, psyllids, soft scales, whiteflies, leafhoppers, weevils, hemiptera, borers, beetles, Delphacidae (e.g., Laodelphax striatellus, Nilaparvata lugens, or Sogatella furcifera); Deltocephalidae (e.g., Nephotettix cincticeps); Aphididae (e.g., Aphis gossypii, Myzus persicae, Brevicoryne brassicae, Macrosiphum euphorbiae, Aulacorthum solani, Rhopalosiphum padi); Pentatomidae (e.g., Nezara antennata, Riptortus clavetus, Leptocorisa chinensis, Eysarcoris parvus, or Halyomorpha mista); Aleyrodidae (e.g., Trialeurodes vaporariorum, Bemisia tabaci); Pyralidae (e.g., Chilo suppressalis, Tryporyza incertulas, Cnaphalocrocis medinalis, Notarcha derogata, Piodia interpunctella, Ostrinia furnacalis or Hellula undalis); Noctuidae (e.g., Spodoptera litura, Spodoptera exigua, Mythimna separata, Mamestra brassicae, Agrotis ipsilon, Plusia nigrisigna, Trichoplusia spp., Heliothis spp., or Helicoverpa spp.); Pieridae (e.g., Pieris rapae); Tortricidae (e.g., Leguminivora glycinivorella, Matsumuraeses azukivora) and Yponomeutidae (e.g., Plutella rylostella); Frankliniella occidentalis, Thrips palmi, Scirtothrips dorsalis, Thrips tabaci, Frankliniella intonsa; Anthomyiidae (e.g., Delia platura, or Delia antiqua); Agromyzidae (e.g., Agromyza oryzae, Hydrellia griseola, Liriomyza sativae, Liriomyza trifolii, or Chromatomyia horticola); Chloropidae (e.g., Chlorops oryzae); Drosophilidae; Diabrotica spp. (e.g., Diabrotica virgifera virgifera, or Diabrotica undecimpunctata howardi); Scarabaeidae (e.g., Anomala cuprea, Anomala rufocuprea, or Popillia japonica); Curculionidae (e.g., Sitophilus zeamais, Lissorhoptrus oryzophilus, Echinocnemus squameus, or Anthonomus grandis); Chrysomelidae (e.g., Oulema oryzae, Aulacophora femoralis, Phyllotreta striolata, or Leptinotarsa decemlineata); Elateridae (Agriotes spp.); Paederus fuscipes; and any other that may cause damage and/or disease to plants.

Further examples of arthropods and/or insects include psyllids such as Asian Citrus Psyllid (Diaphorina citri), an African Citrus Psyllid (Trioza erytreae), a Pear Psyllid (Cacopsylla (Psylla) pyri), a Carrot Psyllid (Trioza apicalis), a Potato Psyllid (Bactericera (Paratrioza) cockerelli), and any psyllid of the family Psyllidae; moths such as European Grapevine Moth (Lobesia botrana or EGVM), False Codling Moth (Thaumatotibia leucotreta or FCM), European Gypsy Moth (Lymantria dispar or EGM), Indian Meal Moth (Plodiainterpunctella), Angoumois Grain Moth (Sitotroga cerealella), Rice moth (Corcyra cephalonica), and Light Brown Apple Moth (Epiphyas postvittana or LBAM); beetles such as Asian Longhorned Beetle (Anoplophora glabripennis, or ALB), Coconut Rhinoceros Beetle (Oryctes rhinoceros), Emerald Ash Borer beetle (Agrilus planipennis or EAB), Rust Red Flour Beetle (Tribolium spp.), Sawtooth Grain Beetle (Oryzaephilussurinamensis), Flat Grain Beetle (Cryptolestes spp.), and Khapra Beetle (Trogoderma granarium); flies such as Mediterranean Fruit Fly (Ceratitis capitata or Medfly), Mexican Fruit Fly (Anastrepha ludens), and Oriental Fruit Fly (Bactrocera dorsalis); flies, such as sand flies, horse flies, tsetse flies, deer flies and eye gnats such as Hippelates; ants such as Imported fire ants (Solenopsis invicta); and mosquitoes such as the genus Anopheles, Trypanosoma, Aedes spp. (e.g., Aedes aegypti), Culex, Mansonia, and Anopheles.

In one embodiment, the method controls viral pests. Examples of viral pests affecting plants, against which the subject invention is useful, include, but are not limited to, Carlavirus, Abutilon, Hordeivirus, Potyvirus, Mastrevirus, Badnavirus, Reoviridae, Fijivirus, Oryzavirus, Phytoreovirus, Mycoreovirus, Rymovirus, Tritimovirus, Ipomovirus, Bymovirus, Cucumovirus, Luteovirus, Begomovirus, Rhabdoviridae, Tospovirus, Comovirus, Sobemovirus, Nepovirus, Tobravirus, Benyvirus, Furovirus, Pecluvirus, Pomovirus; alfalfa mosaic virus; beet mosaic virus; cassava mosaic virus; cowpea mosaic virus; cucumber mosaic virus; panicum mosaic satellite virus; plum pox virus; squash mosaic virus; tobacco mosaic virus; tulip breaking virus; and zucchini yellow mosaic virus.

In some embodiments, the pest is a nematode or other worm-type pest. Examples include, but are not limited to, Meloidogyne spp. (e.g., M. incognita, M. javanica, M. arenaria, M. graminicola, M. chitwoodi or M. hapla); Heterodera spp. (e.g., H. oryzae, H. glycines, H. zeae or H. schachtii); Globodera spp. (e.g., G. pallida or G. rostochiensis); Ditylenchus spp. (e.g., D. dipsaci, D. destructor or D. angustus); Belonolaimus spp.; Rotylenchulus spp. (e.g., R. reniformis); Pratylenchus spp. (e.g., P. coffeae, P. goodeyi or P. zeae); Radopholus spp. (e.g., R. Similis); Hirschmaniella spp. (e.g., H. oryzae); Aphelenchoides spp. (e.g., A. besseyi); Longidorus spp. (e.g., L. macrosoma); Helicotylenchus spp.; Hoplolaimus spp.; Xiphinema spp. (e.g., X. americanum); Paratrichodorus spp. (e.g., P. minor, P. teres); Tylenchorhynchus spp; Mansonella spp. (e.g., M. streptocerca, M. perstans and M. ozzardi); Trichinella, (e.g., T. pseudospiralis, T. native, T. nelsoni, T. britovi); Angiostrongylus spp. (e.g., A. cantonensis, A. costaricensis); Toxocara spp.; Gnathostoma spp. (e.g., G. spinigerum, G. hispidum); Trichodorus similis; Dracunculus medinensis; Loa loa; Criconemoides spp.; Onchocerca volvulu; and Pseudoterranova decipiens.

### Target Plants

As used here, the term “plant” includes, but is not limited to, any species of woody, ornamental or decorative, crop or cereal, fruit plant or vegetable plant, flower or tree, macroalga or microalga, phytoplankton and photosynthetic algae (e.g, green algae Chlamydomonas reinhardtii). “Plant” also includes a unicellular plant (e.g. microalga) and a plurality of plant cells that are largely differentiated into a colony (e.g. volvox) or a structure that is present at any stage of a plant's development. Such structures include, but are not limited to, a fruit, a seed, a shoot, a stem, a leaf, a root, a flower petal, etc. Plants can be standing alone, for example, in a garden, or can be one of many plants, for example, as part of an orchard, crop or pasture.

Example of plants for which the subject invention is useful include, but are not limited to, cereals and grasses (e.g., wheat, barley, rye, oats, rice, maize, sorghum, corn), beets (e.g., sugar or fodder beets); fruit (e.g., grapes, strawberries, raspberries, blackberries, pomaceous fruit, stone fruit, soft fruit, apples, pears, plums, peaches, almonds, cherries or berries); leguminous crops (e.g., beans, lentils, peas or soya); oil crops (e.g., oilseed rape, mustard, poppies, olives, sunflowers, coconut, castor, cocoa or ground nuts); cucurbits (e.g., pumpkins, cucumbers, squash or melons); fiber plants (e.g., cotton, flax, hemp or jute); citrus fruit (e.g., oranges, lemons, grapefruit or tangerines); vegetables (e.g., spinach, lettuce, asparagus, cabbages, carrots, onions, tomatoes, potatoes or bell peppers); Lauraceae (e.g., avocado, Cinnamonium or camphor); and also tobacco, nuts, herbs, spices, medicinal plants, coffee, eggplants, sugarcane, tea, pepper, grapevines, hops, the plantain family, latex plants, cut flowers and ornamentals.

Types of plants that can benefit from application of the products and methods of the subject invention include, but are not limited to: row crops (e.g., corn, soy, sorghum, peanuts, potatoes, etc.), field crops (e.g., alfalfa, wheat, grains, etc.), tree crops (e.g., walnuts, almonds, pecans, hazelnuts, pistachios, etc.), citrus crops (e.g., orange, lemon, grapefruit, etc.), fruit crops (e.g., apples, pears, strawberries, blueberries, blackberries, etc.), turf crops (e.g., sod), ornamentals crops (e.g., flowers, vines, etc.), vegetables (e.g., tomatoes, carrots, etc.), vine crops (e.g., grapes, etc.), forestry (e.g., pine, spruce, eucalyptus, poplar, etc.), managed pastures (any mix of plants used to support grazing animals).

Further plants that can benefit from the products and methods of the invention include all plants that belong to the superfamily Viridiplantae, in particular monocotyledonous and dicotyledonous plants including fodder or forage legumes, ornamental plants, food crops, trees or shrubs selected from Acer spp., Actinidia spp., Abelmoschus spp., Agave sisalana, Agropyron spp., Agrostis stolonifera, Allium spp., Amaranthus spp., Ammophila arenaria, Ananas comosus, Annona spp., Apium graveolens, Arachis spp, Artocarpus spp., Asparagus officinalis, Avena spp. (e.g., A. sativa, A. fatua, A. byzantina, A. fatua var. sativa, A. hybrida), Averrhoa carambola, Bambusa sp., Benincasa hispida, Bertholletia excelsea, Beta vulgaris, Brassica spp. (e.g., B. napus, B. rapa ssp. [canola, oilseed rape, turnip rape]), Cadaba farinosa, Camellia sinensis, Canna indica, Cannabis sativa, Capsicum spp., Carex elata, Carica papaya, Carissa macrocarpa, Carya spp., Carthamus tinctorius, Castanea spp., Ceiba pentandra, Cichorium endivia, Cinnamomum spp., Citrullus lanatus, Citrus spp., Cocos spp., Coffea spp., Colocasia esculenta, Cola spp., Corchorus sp., Coriandrum sativum, Corylus spp., Crataegus spp., Crocus sativus, Cucurbita spp., Cucumis spp., Cynara spp., Daucus carota, Desmodium spp., Dimocarpus longan, Dioscorea spp., Diospyros spp., Echinochloa spp., Elaeis (e.g., E. guineensis, E. oleifera), Eleusine coracana, Eragrostis tef, Erianthus sp., Eriobotrya japonica, Eucalyptus sp., Eugenia un flora, Fagopyrum spp., Fagus spp., Festuca arundinacea, Ficus carica, Fortunella spp., Fragaria spp., Ginkgo biloba, Glycine spp. (e.g., G. max, Soja hispida or Soja max), Gossypium hirsutum, Helianthus spp. (e.g., H. annuus), Hemerocallis fulva, Hibiscus spp., Hordeum spp. (e.g., H. vulgare), Ipomoea batatas, Juglans spp., Lactuca sativa, Lathyrus spp., Lens culinaris, Linum usitatissimum, Litchi chinensis, Lotus spp., Luffa acutangula, Lupinus spp., Luzula sylvatica, Lycopersicon spp. (e.g., L. esculentum, L. lycopersicum, L. pyriforme), Macrotyloma spp., Malus spp., Malpighia emarginata, Mammea americana, Mangifera indica, Manihot spp., Manilkara zapota, Medicago sativa, Melilotus spp., Mentha spp., Miscanthus sinensis, Momordica spp., Morus nigra, Musa spp., Nicotiana spp., Olea spp., Opuntia spp., Ornithopus spp., Oryza spp. (e.g., O. sativa, O. latifolia), Panicum miliaceum, Panicum virgatum, Passiflora edulis, Pastinaca sativa, Pennisetum sp., Persea spp., Petroselinum crispum, Phalaris arundinacea, Phaseolus spp., Phleum pratense, Phoenix spp., Phragmites australis, Physalis spp., Pinus spp., Pistacia vera, Pisum spp., Poa spp., Populus spp., Prosopis spp., Prunus spp., Psidium spp., Punica granatum, Pyrus communis, Quercus spp., Raphanus sativus, Rheum rhabarbarum, Ribes spp., Ricinus communis, Rubus spp., Saccharum spp., Salix sp., Sambucus spp., Secale cereale, Sesamum spp., Sinapis sp., Solanum spp. (e.g., S. tuberosum, S. integrifolium or S. lycopersicum), Sorghum bicolor, Spinacia spp., Syzygium spp., Tagetes spp., Tamarindus indica, Theobroma cacao, Trifolium spp., Tripsacum dactyloides, Triticosecale rimpaui, Triticum spp. (e.g., T. aestivum, T. durum, T. turgidum, T. hybernum, T. macha, T. sativum, T. monococcum or T. vulgare), Tropaeolum minus, Tropaeolum majus, Vaccinium spp., Vicia spp., Vigna spp., Viola odorata, Vitis spp., Zea mays, Zizania palustris, Ziziphus spp., amongst others.

Further examples of plants of interest include, but are not limited to, corn (Zea mays), Brassica sp. (e.g., B. napus, B. rapa, B. juncea), particularly those Brassica species useful as sources of seed oil, alfalfa (Medicago saliva), rice (Oryza sativa), rye (Secale cereale), sorghum (Sorghum bicolor, Sorghum vulgare), millet (e.g., pearl millet (Pennisetum glaucum), proso millet (Panicum miliaceum), foxtail millet (Setaria italica), finger millet (Eleusine coracana)), sunflower (Helianthus annuus), safflower (Carthamus tinctorius), wheat (Triticum aestivum), soybean (Glycine max), tobacco (Nicotiana tabacum), potato (Solanum tuberosum), peanuts (Arachis hypogaea), cotton (Gossypium barbadense, Gossypium hirsutum), sweet potato (Ipomoea batatus), cassava (Manihot esculenta), coffee (Coffea spp.), coconut (Cocos nucifera), pineapple (Ananas comosus), citrus trees (Citrus spp.), cocoa (Theobroma cacao), tea (Camellia sinensis), banana (Musa spp.), avocado (Persea americana), fig (Ficus casica), guava (Psidium guajava), mango (Mangifera indica), olive (Olea europaea), papaya (Carica papaya), cashew (Anacardium occidentale), macadamia (Macadamia integrifolia), almond (Prunus amygdalus), sugar beets (Beta vulgaris), sugarcane (Saccharum spp.), oats, barley, vegetables, ornamentals, and conifers. Vegetables include tomatoes (Lycopersicon esculentum), lettuce (e.g., Lactuca sativa), green beans (Phaseolus vulgaris), lima beans (Phaseolus limensis), peas (Lathyrus spp.), and members of the genus Cucumis such as cucumber (C. sativus), cantaloupe (C. cantalupensis), and musk melon (C. melo). Ornamentals include azalea (Rhododendron spp.), hydrangea (Macrophylla hydrangea), hibiscus (Hibiscus rosasanensis), roses (Rosa spp.), tulips (Tulipa spp.), daffodils (Narcissus spp.), petunias (Petunia hybrida), carnation (Dianthus caryophyllus), poinsettia (Euphorbia pukherrima), and chrysanthemum. Conifers that may be employed in practicing the embodiments include, for example, pines such as loblolly pine (Pinus taeda), slash pine (Pinus elliotii), ponderosa pine (Pinus ponderosa), lodgepole pine (Pinus contorta), and Monterey pine (Pinus radiata); Douglas-fir (Pseudotsuga menziesii); Western hemlock (Tsuga canadensis); Sitka spruce (Picea glauca); redwood (Sequoia sempervirens); true firs such as silver fir (Abies amabilis) and balsam fir (Abies balsamea); and cedars such as Western red cedar (Thuja plicata) and Alaska yellow-cedar (Chamaecyparis nootkatensis). Plants of the embodiments include crop plants (for example, corn, alfalfa, sunflower, Brassica, soybean, cotton, safflower, peanut, sorghum, wheat, millet, tobacco, etc.), such as corn and soybean plants.

Turfgrasses include, but are not limited to: annual bluegrass (Poa annua); annual ryegrass (Lolium multiflorum); Canada bluegrass (Poa compressa); Chewings fescue (Festuca rubra); colonial bentgrass (Agrostis tenuis); creeping bentgrass (Agrostis palustris); crested wheatgrass (Agropyron desertorum); fairway wheatgrass (Agropyron cristatum); hard fescue (Festuca longifolia); Kentucky bluegrass (Poa pratensis); orchardgrass (Dactylis glomerate); perennial ryegrass (Lolium perenne); red fescue (Festuca rubra); redtop (Agrostis alba); rough bluegrass (Poa trivialis); sheep fescue (Festuca ovine); smooth bromegrass (Bromus inermis); tall fescue (Festuca arundinacea); timothy (Phleum pretense); velvet bentgrass (Agrostis canine); weeping alkaligrass (Puccinellia distans); western wheatgrass (Agropyron smithii); Bermuda grass (Cynodon spp.); St. Augustine grass (Stenotaphrum secundatum); zoysia grass (Zoysia spp.); Bahia grass (Paspalum notatum); carpet grass (Axonopus affinis); centipede grass (Eremochloa ophiuroides); kikuyu grass (Pennisetum clandesinum); seashore paspalum (Paspalum vaginatum); blue gramma (Bouteloua gracilis); buffalo grass (Buchloe dactyloids); sideoats gramma (Bouteloua curtipendula).

Plants of interest include grain plants that provide seeds of interest, oil-seed plants, and leguminous plants. Seeds of interest include grain seeds, such as corn, wheat, barley, rice, sorghum, rye, millet, etc. Oil-seed plants include cotton, soybean, safflower, sunflower, Brassica, maize, alfalfa, palm, coconut, flax, castor, olive etc. Leguminous plants include beans and peas. Beans include guar, locust bean, fenugreek, soybean, garden beans, cowpea, mungbean, lima bean, fava bean, lentils, chickpea, etc.

Further plants of interest include Cannabis (e.g., sativa, indica, and ruderalis) and industrial hemp.

All plants and plant parts can be treated in accordance with the invention. In this context, plants are understood as meaning all plants and plant populations such as desired and undesired wild plants or crop plants (including naturally occurring crop plants). Crop plants can be plants that can be obtained by traditional breeding and optimization methods or by biotechnological and recombinant methods, or combinations of these methods, including the transgenic plants and the plant varieties. Plant parts are understood as meaning all aerial and subterranean parts and organs of the plants such as shoot, leaf, flower and root, examples which may be mentioned being leaves, needles, stalks, stems, flowers, fruit bodies, fruits and seeds, but also roots, tubers and rhizomes. The plant parts also include crop material and vegetative and generative propagation material, for example cuttings, tubers, rhizomes, slips and seeds.

1. A composition for controlling agricultural pests, the composition comprising a hydrolysate of a microorganism, and one or more biosurfactants produced by the microorganism during cultivation thereof, and
wherein the microorganism is a yeast selected from Stermerella bombicola, Wickerhamomyces anomalus, Pseudozyma aphidis, Pichia guilliermondii or Saccharomyces cerevisiae or a bacterium selected from Bacillus subtilis, Bacillus amyloliquefaciens, Bacillus lichenifbrmis, Bacillus chitinosporous, Rhodococcus erythropolis or Pseudomonas chlororaphis.

2. The composition of claim 1, comprising a biosurfactant selected from sophorolipids, rhamnolipids, mannosylerythritol lipids, trehalose lipids and cellobiose lipids.

3-4. (canceled)

5. The composition of claim 1, formulated as a dry powder or as granules.

6. (canceled)

7. The composition of claim 1, further comprising a natural pesticide and/or pest repellant selected from diatomaceous earth, chitinase, lemon eucalyptus oil, citronella, peppermint oil, mineral oils, garlic extract, and chili extract.

8. The composition of claim 1, further comprising an adherent substance.

9. (canceled)

10. The composition of claim 8, wherein the adherent substance is xanthan gum, guar gum, levan, xylinan, welan gum, gellan gum, curdlan, and/or pullulan.

11-20. (canceled)

21. A method for controlling an agricultural pest, said method comprises contacting the pest with a composition of claim 1.

22-23. (canceled)

24. The method of claim 21, formulated as a dry powder or as granules.

25. (canceled)

26. The method of claim 21, wherein the composition further comprises a natural pesticide and/or pest repellant selected from diatomaceous earth, chitinase, lemon eucalyptus oil, citronella, peppermint oil, mineral oils, garlic extract, and chili extract.

27-29. (canceled)

30. The method of claim 21, wherein the composition is mixed with water prior to application.

31. The method of claim 21, wherein the composition is applied to a plant's roots.

32. The method of claim 31, wherein applying the composition to the plant's roots comprises contacting the composition directly with the roots or with soil in which the plant grows.

33. The method of claim 21, wherein the composition is applied to a plant's above-ground mass, said above-ground mass comprising foliage, stems, trunks, and/or flowers.

34. The method of claim 21, wherein the composition is applied to the pest, plant, and/or plant environment using an irrigation system.

35. The method of claim 21, used to control pests selected from nematodes, arthropods, bacteria, viruses, fungi, protozoa, and parasites.

36. The method of claim 21, wherein the plants are selected from citrus, tomato, sugar beet, soybean, corn, potato, sugarcane, grapes, lettuce, almond, onion, carrot, berries, cotton, sod and turfgrasses.

37. The method of claim 21, wherein the plant is a citrus plant affected by citrus greening disease and/or citrus canker disease.

38. The method of claim 21, wherein the composition is applied using a handheld lawn and garden sprayer.

39. The method of claim 38, wherein the method is used for home and garden applications. 40. The method of claim 21, wherein the composition comprises a biosurfactant selected from sophorolipids, rhamnolipids, mannosylerythritol lipids, trehalose lipids and cellobiose lipids
